(19) United States
(12) Patent Application Publication
(10) Pub. No.: US 2004/0046656 A1
(43) Pub. Date: Mar. 11, 2004

(54) Wireless communications system

(76) Inventors: Robert A. Schaefer, San Francisco, CA (US); Shahid Javed, Brisbane, CA (US)

Correspondence Address: Paul K. Tomita, Dergosits & Noah LLP, Suite 1450, Four Embarcadero Center, San Francisco, CA, 94111, US

(21) Appl. No.: 10/242,333

(22) Filed: Sep. 11, 2002

(51) Int. Cl. G08B 1/08

(52) U.S. Cl. 340/539.11

(57) ABSTRACT

A system for wireless communications includes multiple portable digital devices which automatically and selectively communicate with each other. Each portable digital device has a proximity transceiver and an electronic memory which stores the user's personal information and search information. During operation, the portable digital devices communicate with each other by transmitting signals through the proximity transceivers. A compatibility analysis is performed to determine if their users are compatible by comparing the personal information of each user to the search data of the other user. If the first user's personal information matches the second user's search data and the second user's personal information matches the first user's search data, both users are notified that they are compatible and information is electronically exchanged.

### BACKGROUND

Radio frequency communications have existed for many years and are now used for a wide variety of applications. Large systems are capable of transmitting voice and digital information wirelessly over large distances. As radio frequency technology has progressed, the transceivers have become smaller and more energy efficient. Personal cell phones, pagers and other radio frequency communications devices have become well known consumer electronics. Some personal digital assistants (PDAs) utilize radio frequency technology to wirelessly access the internet.

Short range radio frequency communications such as Bluetooth have been developed which have a limited communications range but are highly energy efficient. Short range radio frequency transceivers are used for communications between personal computers and peripheral devices such as: PDAs, keyboards, mice, and printers. Energy efficiency is of particular importance to portable peripheral devices which are generally powered by rechargeable batteries.

Some systems have been developed which allow users of radio frequency devices having a “common interest” to communicate or exchange information with each other. In these systems, a data signal is wirelessly transmitted from a first radio frequency (RF) device to a second RF device. The data signal includes encoded information indicative of a specific interest. If the second device determines that there is a common interest based upon the received data signal, additional information wirelessly exchanges with the first RF device.

A problem with these common interest communications systems is that users are matched based only upon a common interest. The exchange of information is not prevented between users who are incompatible. For example, the common interest system would be problematic if used for dating applications because it does not take into account the users' gender and sexual orientation. Using these common interest systems, two people having the common interest of music would exchange information with each other even if their gender and/or sexual orientation are incompatible for dating. What is needed is a more intelligent matching system which matches users based upon the compatibility of the individuals rather than simply a common interest.

### SUMMARY OF THE INVENTION

The present invention is a wireless communications system which allows portable digital devices (PDDs) to automatically and selectively exchange information with other PDDs which are within the vicinity of each other. The portable digital devices (PDDs) are small battery operated units containing a microprocessor, an electronic memory and short range radio frequency transceivers. Personal information and search data for the user are downloaded to the PDD using a personal computer or directly input into the PDD.

The PDDs are carried by their users into areas where other PDD users may be present. Because the personal digital devices utilize short range radio frequency transceivers, communications are limited to PDDs which are within the transceiver transmission range. Each PDD runs a program which automatically initiates communications with other PDDs within the transmission range of the radio frequency transceiver. The communicating PDDs exchange the personal information of their users via radio frequency communications. The personal information of the users is analyzed for a match by comparing each user's personal information to the other user's search data. A match requires that the first user's personal information matches the search data of the second user and the second user's personal information matches the search data of the first user.

When a match occurs the users' contact information is electronically exchanged and stored on each portable digital device. In an embodiment, the contact information may be used to look up additional information about the other user on a database or correspond via e-mail or interact on a world wide web chat room. If the personal information of a user does not match the search data of the other user, then contact information is not exchanged. The personal information may include an identification code which is stored on the receiving PDD and used to future prevent communications with the same PDD more than once before being reset. In some cases the memory may be insufficient to hold the identification codes of all PPDs which had previous communications. When the memory is full some identification codes are removed. A “FIFO” (First In First Out) system may be used in which the first identification codes stored in memory are the first to be removed.

In addition to exchanging contact information, a match indicator on the PDD is actuated which informs the users that a person having personal information which matches the user's search data is in the vicinity. The match indicator can be manually set to be a light, vibration, sound or any other signal. When the match indicator is actuated, the PDD does not communicate with other PDDs. After being actuated, the match indicator can be manually turned off to reset the PDD so that it can continue to communicate with other PDDs. The PDD stores the identifications of previously matched PDDs and prevents rematching with these PDDs. The portable digital device may match with many other PDDs and the contact information for each of the matches may be stored in memory.

In most situations it is desirable to contact the matched user soon after being informed of a match, however it is also possible for the user to deactive the indicator and access the acquired contact information at a later time. The PDD may have a visual display which can be used to display the contact information. Alternatively, the PDD may be connected to a personal computer which can download and display the contact information.

In the preferred embodiment, the PDD is used with a personal computer that has access to the internet and a server computer which stores a database of PDD user profiles. Because the PDD user database may contain confidential information, certain safeguards may be implemented to prevent unauthorized access. The exchanged contract information may include an authorization code which allows access to the PDD user's database profile stored on the database. The database profile includes additional information about the individual which may be of interest to the matched user.

The inventive wireless communications system provides users with a means for automatically and selectively exchanging information with other compatible PDD users. The communications system has a variety of entertainment, disability and business applications which will be described in more detail.

### BRIEF DESCRIPTION OF THE DRAWINGS

The invention is herein described, by way of example only, with reference to embodiments of the present invention illustrated in the accompanying drawings, wherein:

FIG. 1 illustrates the four ways in which the portable digital device may be carried by the user;

FIG. 2 illustrates the variable transmission radius of the personal digital device;

FIG. 3 illustrates transmission radius requirements for communications between personal digital devices;

FIG. 4 illustrates an embodiment of the inventive system in which the portable digital devices require an enabling signal for communications;

FIG. 5 illustrates two configurations for downloading the program onto a personal computer;

FIG. 6 illustrates three configurations for connecting the PDD to the personal computer;

FIG. 7 illustrates a screen shot of an exemplary graphical user interface for inputting a user's personal information;

FIG. 8 illustrates a flow chart of the operation of the portable digital device in a peer to peer operating mode;

FIG. 9 illustrates a flowchart of the operation of the PDD in an enabling signal mode;

FIG. 10 illustrates a flow chart of the PDD operation in which a host computer performs the primary data processing; FIG. 11 illustrates a block diagram of the components of the portable digital device;

FIG. 12 illustrates a block diagram of some components of the portable digital device which may be fabricated as one or two application specific integrated circuits. .

### DETAILED DESCRIPTION

The inventive wireless communications system allows portable digital devices (PDDs) to automatically communicate and selectively exchange information with other PDDs when the devices are within the transmission radius of each other. The PDDs are small devices which contain personal information about the user and search data which is also input by the user. The PDD may be worn or carried by a user as he or she attends social gatherings.

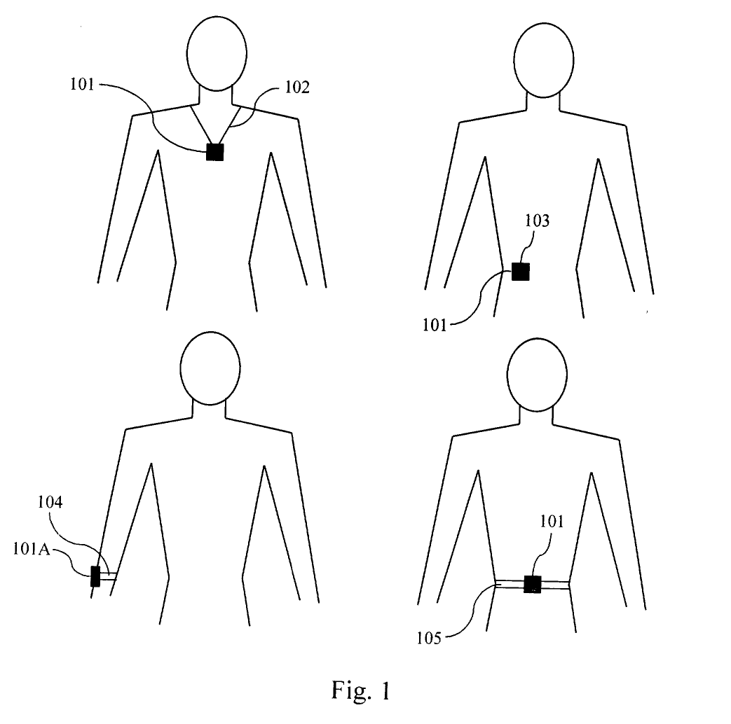

With reference to FIG. 1, various means for wearing the PDD 101 are illustrated. The PDD 101 is a very small device and light weight. The small physical characteristics allow the PDD 101 to be easily worn, carried or even integrated into various consumer electronic devices including mobile phones, wrist watches and personal digital assistants (PDAs). The PDD 101 may be placed within a pendant which is attached to a necklace 102 and worn around a user's neck. The pendant may be a sculptured piece which is preferably made of a material which is transparent to radio frequency waves. The PDD 101 may have a clip 103 which can be attached to the user's clothing or integrated into a pager. The PDD 101 may be attached to a bracelet 104 which can be worn on the user's wrist, jewelry or integrated into a wrist watch. The PDD 101 may also be attached to a waist band or belt 105 which is worn by the user. Alternatively, the PDD 101 may be simply carried by the user in his or her pocket or purse.

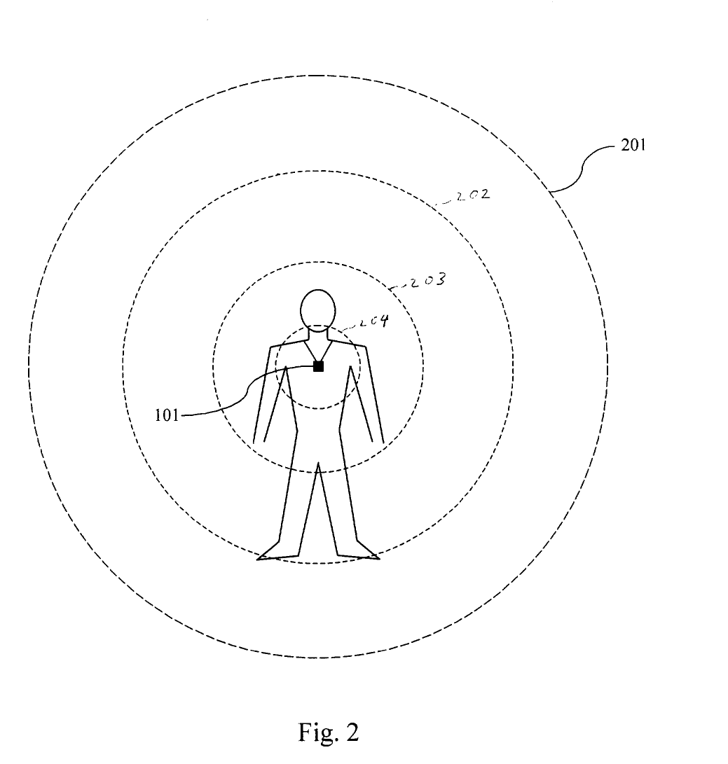

The PDD is configured to communicate with other PDDs which are in physical proximity. With reference to FIG. 2, the PDD 101 has a specific transmission radius 201 which may extend about 30 feet from the user. The transmitter strength of the PDD 101 may be controllable by varying the power output of the transmitter. By reducing the power to the transmitter, the radius of transmission of the PDD's 101 is reduced. In an embodiment, the PDD may be able to adjust the communications range between a long transmission radius 201, a medium transmission radius 202, a short transmission radius 203 and a very short transmission radius 204. The longer transmission radius 201 will be able to communicate with a larger area of PDD users. The shorter transmission radii 203, 204 have the benefit of lower power consumption and longer battery life. The shorter transmission radii may also improve the effectiveness of the PDD in a crowded space by only communicating with other PDDs in a closer proximity to the user.

The user may control the transmission radius using a manual switch on the PDD which adjusts the power output of the RF transmitter. Alternatively, the PDD may include an automatic RF transmitter power output controller which is controlled by the number of PDDs detected. If a large number of PDDs are detected the PDD can automatically reduce the transmission radius thereby reducing the number of detected PDDs. Conversely, if few PDDs are detected, the PDD can automatically increase the transmission radius. By adjusting the transmission radius the PDD detection rate can be regulated to a level which is manageable by the PDD.

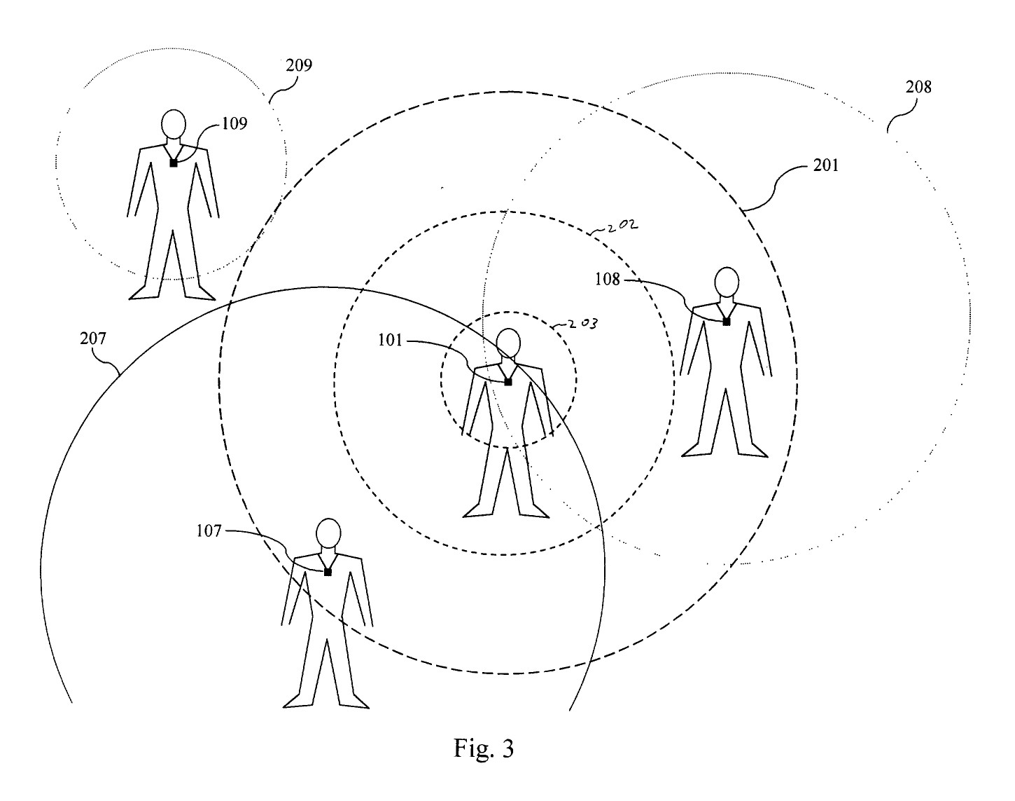

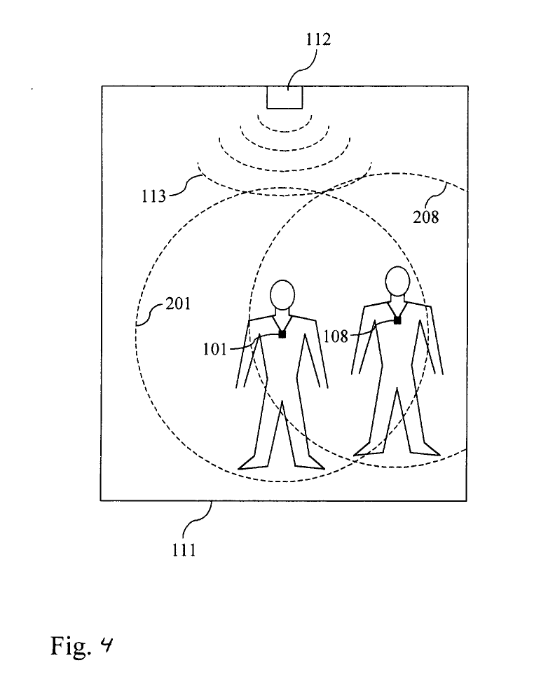

FIG. 3 illustrates a group of PDDs 101, 107, 108, 109 some of which can communicate with each other. If the first PDD 101 is transmitting at the long transmission radius 201, the first PDD 101 can communicate with a second PDD 107 and a third PDD 108. The first PDD 101 can communicate with the second PDD 107 because the second PDD 107 is within transmission radius 201 and the first PDD 101 is within transmission radius 207. Similarly, the first PDD 101 can communicate with the third PDD 108 because the third PDD 108 is within transmission radius 201 and the first PDD 101 is within transmission radius 208. The first PDD 101 cannot communicate with a forth PDD 109 because the fourth PDD 109 is outside transmission radius 201 and also because the first PDD 101 is outside transmission radius 209.

If the transmitter power for the first PDD 101 is reduced to transmission radius 202, communications with the second PDD 107 and a third PDD 108 are no longer be possible. Although the first PDD 101 is within transmission radius 207 and transmission radius 208, neither the second PDD 107 nor the third PDD 108 are within transmission radius 202. Communications between the second PDD 107, the third PDD 108 and the forth PDD 109 is not possible because none of these PDDs are within the respective transmission radii 207, 208, 209.

In an embodiment, communications between PDDs requires an enabling signal to be received by the PDDs and each PDD to be within the transmission range of the other PDD. FIG. 4 illustrates a transmitter 112 which emits an RF enabling signal 113 which is received by a first PDD 101 and a second PDD 108. The transmitter 112 may be controlled by a host computer (not shown). After receiving the enabling signal 113 the PDDs 101, 108 can communicate because the first PDD 101 is within transmission radius 208 and the second PDD 108 is within transmission range 201. The enabling signal embodiment allows communications between PDDs 101, 108 to be controlled by a third party.

In an embodiment, the enabling signal 113 emanating from the transmitter 112 is used to control communications between PDDs 101, 108 within a defined space 111. The transmitter 112 power output may not be restricted by a limited electrical power supply and may have a very long transmission radius which allows all PDDs within the room 111 to communicate.

In another embodiment, the transmitter 112 may emit a disabling signal 113 which functions to deactivate communications between the PDDs 101, 108. In this embodiment, communications are possible when the first PDD 101 is within transmission range 208 and the second PDD 108 is within transmission range 201 and a disabling signal 113 is not received. In this embodiment the PDDs 101, 108 can normally communicate independently however, communications can be terminated by transmitting a disabling signal 113. When the PDDs 101, 108 receive the disabling signal, they may display a message indicating that communications are not authorized.

Alternatively, if the room in which communications are to be controlled is large or complex in shape or a lower transmission radius is desired, multiple transmitters can be dispersed throughout the room. By dispersing multiple transmitters all areas of the room may be within the transmission radius of a least one transmitter. The transmitters do not have to be within the transmission radii of the PDDs to control communications between PDDs within a defined space. The enabling or deactivation signal allows communications between PDDs in a defined area to be controlled by a third party. The third party may be the owner or manager and the defined area may be a building or an open space. The defined area may be a club having specific hours of operation. The owner or manager can discontinue the operation of all PDDs within the club by turning off the enabling signal or turning on a deactivation signal. By terminating PDD communications patrons may have an incentive to leave the club. Similarly, PDD communications can be temporarily suspended if for example a public announcement needs be made or in the event of an emergency.

For the PDD to perform the matching operation, the user's personal information and the user's search data must be input into the PDD's memory. There are various methods for transferring information to the PDD memory. In the preferred embodiment, the personal information and search data are loaded into the PDD's memory using a personal computer and a data input program. The data input program provides a graphical user interface which is displayed on the computer screen and allows the user to input his or her personal information and search data.

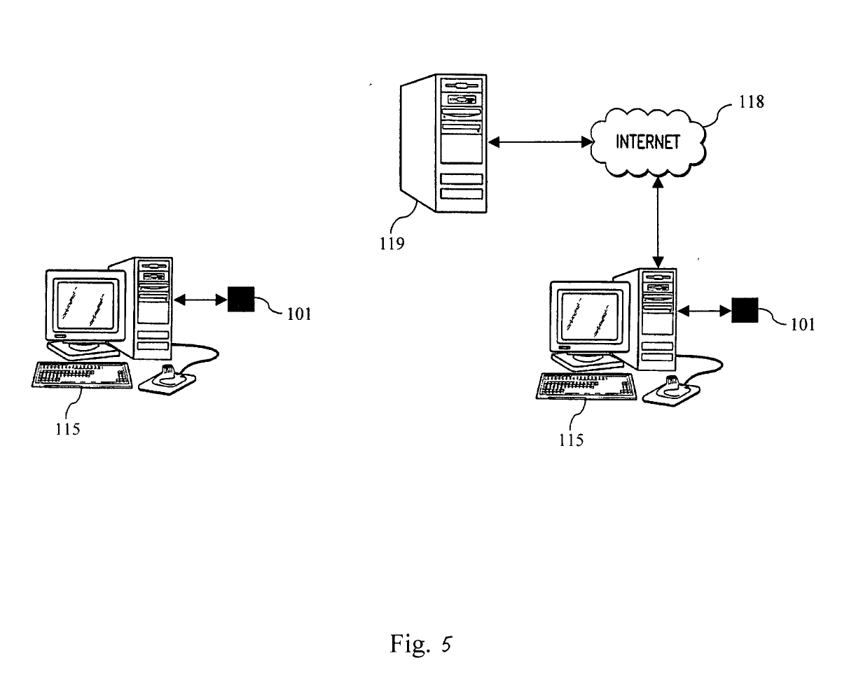

FIG. 5 illustrates two exemplary configurations for downloading the program onto a personal computer. The program may be loaded onto the computer 115 through portable media such as a disc containing the program. Alternatively, the program may be downloaded from a server computer 119 which is accessible by the computer 115 through the internet 118. In another embodiment, the program may exist only on the server computer 119 and the program may be accessed by the computer 115 through the internet 118 using a web browser program.

The memory of the PPD may be limited, so it may be necessary for the computer to compress the personal information and search data so that it fits into the allotted PPD memory. Various known data compression methods may be used. In an embodiment, the personal information and search data are converted into short digital codes which are arranged in a specific sequence or otherwise compressed using an algorithm.

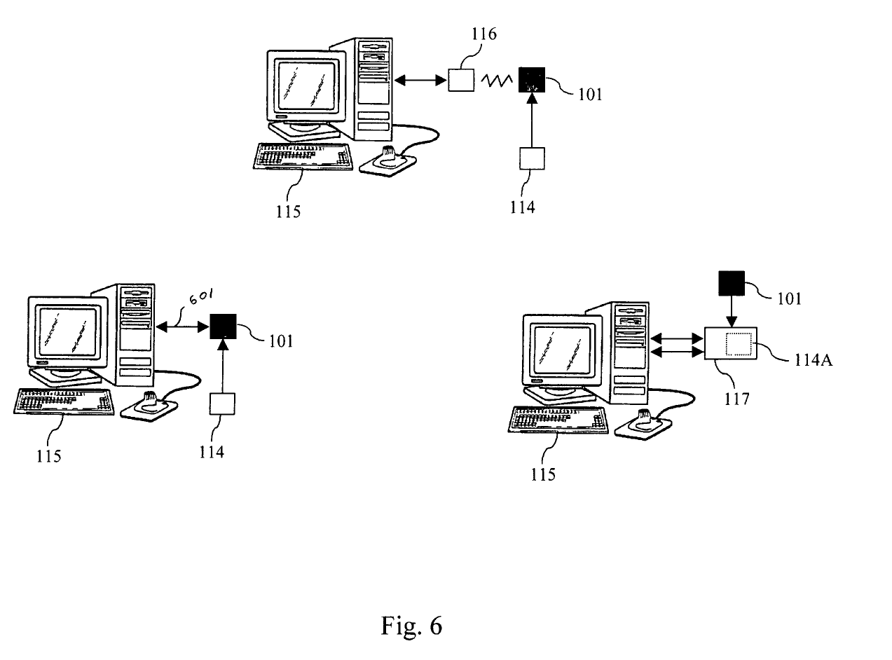

FIG. 6 illustrates three exemplary configurations for connecting the PDD 101 to the personal computer 115. The PDD 101 may be connected directly to the personal computer 115 using a wired cable 601. The wired cable 601 may be a USB, serial, RS-232 or any other type of cable including optical which is capable of transmitting data between the PDD 101 and the computer 115. Power to recharge the PDD 101 batteries may be supplied by an external power source 114 such as an AC adapter which would plug into a standard electrical outlet. Alternatively, electrical power to recharge the battery may be drawn from the computer 1 15 through the cable 601.

The PDD 101 may utilize its wireless RF transceiver to exchange information with the computer 115. A compatible wireless RF transceiver 116 may be attached to the computer 115 and information may be exchanged by placing the PDD 101 within the transmission radius of the computer's 115 RF transceiver 116. The wireless communications have the advantage of not requiring a physical connection between the computer 115 and the PDD 101. In this embodiment, electrical power may be supplied to the PDD 101 through an external power source 114.

In yet another embodiment, a docking station 117 is connected to the computer 115. The PDD 101 is placed in the docking station 117 to connect the PDD 101 to the computer 115 and an external power source 116. The docking station 117 may also have control buttons which can be used by the user to initiate the exchange of information or synchronize data stored on the PDD 101 and the computer 115. The docking station 117 is the preferred system because it provides the simplest connection between the PDD 101 and the computer 115.

In yet another embodiment, the PDD may be a module or integrated analog-digital chip which is inserted into a PDA device such as a Palm, Casio, Sony or Handspring PDA. Most PDAs are able to exchange information with a computer through a cable, cradle, wireless infrared or RF transceivers. Some other PDAs such as the Palm VII and Handspring Treo have wireless internet access which may also serve as a communications connection with a computer. In this embodiment, the personal information and search data may be downloaded onto the PDD using any of the existing communications or data input capabilities of the PDA device.

In an embodiment, the inventive system may be an entertainment device used for dating by adults. The personal information relevant to dating may include: gender, sexual orientation, age, ethnicity, physical characteristics, education, income, etc. The search data will include information which is representative of the type of person that the user would like to date and will include: gender, sexual orientation, age range, ethnicity, physical characteristics, education, income, etc. The search data may be the same categories as the personal information but allow for an acceptable range in certain situations.

Because personal information and search data can be highly confidential, an encryption or security scheme may be used to prevent confidential information from being accessible to unauthorized individuals. The encryption method converts the confidential information into a format that is not easily deciphered by an unintended recipient of the information. Similarly, secure communication channels are not easily intercepted by an unintended recipient. Using these known systems, personal information and search data is protected from unauthorized dissemination.

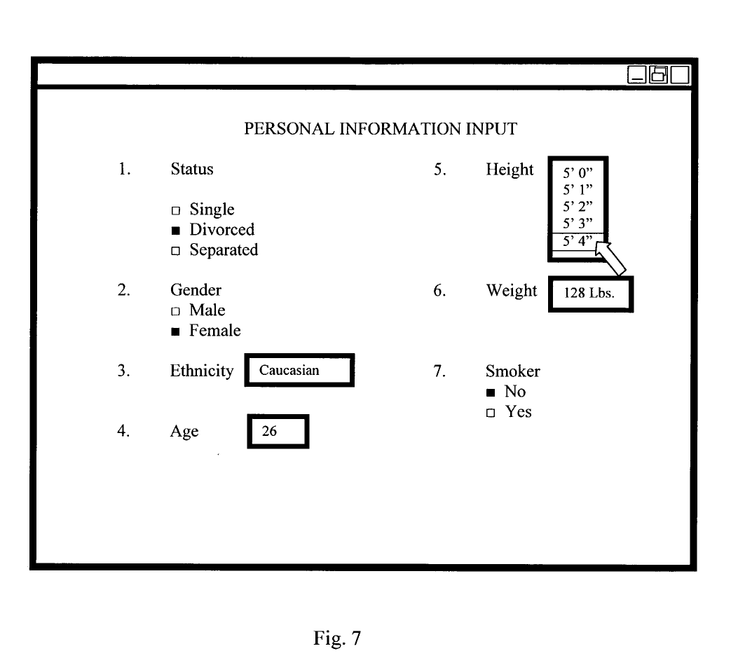

An example of the graphical user interface used to input the personal information is illustrated in FIG. 7. For example, the first input is “Status.” The user can input this information by pointing the cursor over the appropriate input “Single” or “Divorced” or “Separated” and clicking a button on the computer's input device. Other information such as age can by input by typing in the appropriate number through the computer keyboard or by clicking on a drop down menu inputs. In certain input fields, it may be appropriate to input text to create a more detailed and unique personal information file.

The search data inputs may be similar to the personal information except that the search data is representative of a person that the user is interested in dating and exchanging contact information with. The search data is typically broader than the personal information. For example in a dating application, the search data inputs may be a range of ages, heights, and weights. The search data may also include a keyword(s) which must appear in a compatible personal information file for a match. A graphical user interface like that used to input the personal information is used to input for the search data.

The inventive system for matching of personal information and search data between two individuals is a screening method which may also be used with a database for improved search results. Many internet dating systems exist which have accessible databases of users which allow individuals to search through published listings of members profiles. The profiles on the database contain detailed text information about the member and frequently also contain a photograph of the member. When search data describing a person is input, the system searches the database and produces a listing of service member profiles which meet the search data. The recipient of the listing must then go through each profile in the listing to determine if there is a potential match. Frequently the recipient does not meet the requirements of the listed profile.

If the inventive search method were utilized, the user would input both personal information and search data. The search data would be used to extract a listing of potential matches from the database. The system would then compare the search data of the listed potential matches with the personal information of the user. A final listing of matches would then be produced in which the listed profiles met the users search data and the user met the listed profiles search data. The inventive search system would greatly improve the efficiency of these internet dating services.

The same information used to create a profile for an internet dating service can be used as the personal information and search data of the inventive PDD. Before loading onto the PDD, the electronic personal information and search data files may be compressed or converted into a more memory efficient format. The conversion accurately represents the personal information and search data but requires much less electronic memory. The PDD has a limited memory so reducing the size of the personal information and search data may be required allows the information to be loaded onto the PDD. If the PDD has sufficient memory this compression of personal information and search data may not be required.

When using the inventive communications system in a dating application, multiple PDD users may gather in a location. When communications between two or more PDDs are established, each PDD transmits the personal information to the other user's PDD. The received personal information is compared to the search data. For example, the first user may have the personal information and search information listed in Table 1.

TABLE 1

| | Status | Sex | Ethnicity | Age | Height | Weight | Smoker |
|---|---|---|---|---|---|---|---|
| First User | Single | Male | Hispanic | 28 | 6′ | 185 lbs. | Yes |
| Personal Info | | | | | | | |
| First User | Single or | Female | Any | 22-31 | any | 150 lbs. | Yes or No |
| Search Data | Divorced | | | | | or less | |
| Second User | Divorced | Female | Caucasian | 26 | 5′4″ | 128 lbs. | No |
| Personal Info | | | | | | | |
| Second User | Single or | Male | Any | 24-33 | 5′5″- | 210 lbs. | Yes or No |
| Search Data | Divorced | | | | 6′6″ | or less | |

The first user's PDD transmits the first user personal information to the second user's PDD and the second user's PDD transmits the second user personal information to the first user's PDD. The second user's PDD compares the first user personal information to the second user search data and determines that the first user's personal information matches the second user search data in all categories. Similarly, the first user's PDD compares the second user personal information to the first user search data. The second user personal information matches the first user search data in the status, sex, ethnicity, age, height, weight and smoking categories. Similarly, the second user personal information completely matches the first user search data. Because both sets of personal information matches the search data, the PDDs exchange contact information and the indicators on both PDDs are actuated. If either user's set of personal information does not match all categories of the search data, a match will not be established and contact information will not be exchanged. The personal information includes an identification code which prevents redundant communications between PDDs.

The indicators inform the users of the PDDs that a match has been established in the transmission proximity. Because the transmission range of the PDDs is short, the users should be able to meet each other. The indicator may be a light, a vibrator, a speaker or any other mechanism which can inform the user that a match has been detected. The PDD may be deactivated while the indicator is on, allowing the matched users to converse without interruption. Alternatively, the indicators can be turned off while the PDD is still active so that the PDD can continue to communicate with other PDDs without informing the user of matches.

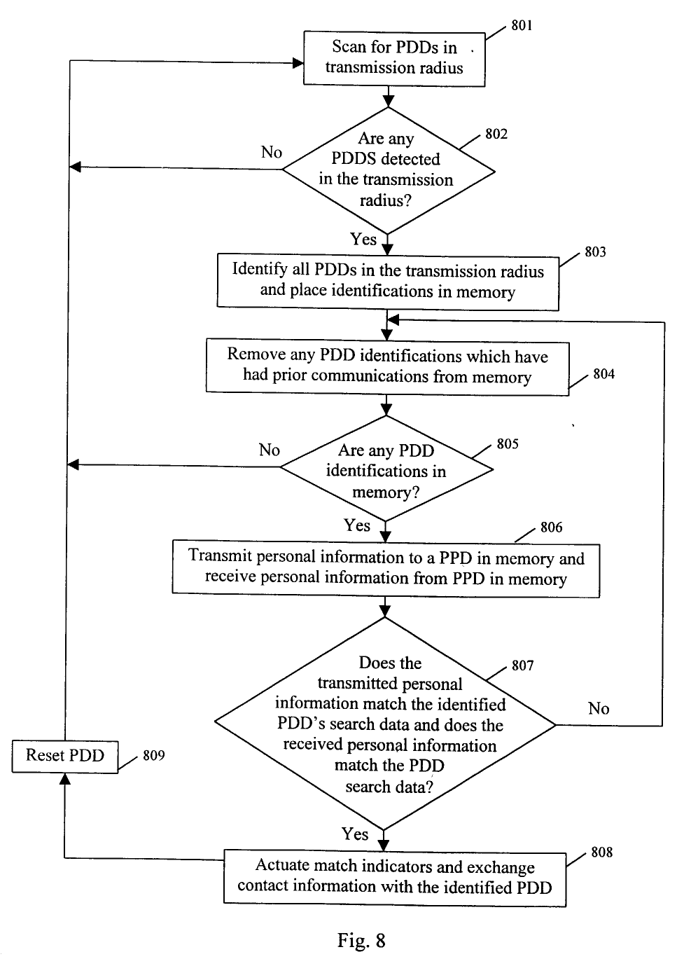

The PDD operation in a peer to peer mode of operation is described with reference to the flow chart illustrated in FIG. 8. When the PPD is operating it scans the area for any other PDD that are within the RF transmission range 801. The scanning can include transmitting a communications signal and waiting for a response from other PDDs in the area. If two PDDs are transmitting at the same time and at the same radio frequency, a “collision” can occur causing data communications to fail. The PDDs may have an arbitration scheme in which the PDDs detects that a collision has taken place and waits a predetermined period of time before each PDD retransmits. Alternatively, collisions on a single radio frequency may be avoided by utilizing a frequency hopping algorithm or a spread spectrum algorithm which are known methods of preventing communication interruptions due to collisions.

The PDD then detects if there are any devices in the RF transmission radius 802.

The detection can occur by receiving a response signal which includes an identification code. If the PDD does not detect any devices in the RF transmission radiusit returns to the scanning step 801. If other PDDs are detected in the transmission radius, the PDD obtains the identification codes for the individual PDDs in the transmission radius and stores the identification codes in memory 803. The identification codes of PDD which have had prior communications are then removed from the memory 804. The PDD then checks the memory to determine if there are any remaining PDD identification codes 805. If there are no identification codes in memory, the PDD goes back to the scanning step 801.

If there are PDD identification codes in memory, the PDD establishes communications with one of the PDDs in memory (local PDD). The PDD transmits the user's personal information to the local PDD and the PDD receives the local PDD's personal information 806. The PDD compares the local PDD's personal information with the PDD's search data and similarly the local PDD compares the PDD's personal information with the local PDD's search data 807. If the local PDD's personal information matches the PDD's search data and the PDD's personal information matches the local PDD's seach data, the PDD and the local PDD are “matched.” If there is a match, the match indicators of the PDD and local PDD are actuated and contact information for the matched PDDs can be wirelessly exchanged 808. If the local PDD's personal information does not match the PDD's search data or the PDD's personal information does not match the local PDD's search data, a match is not established. If a match is not established, the PDD does back to the scanning for PDDs in the transmission radius step 801.

In a different embodiment, communications between PDDs requires a host computer which can individually control the communications of each PDD within a specific area. The host computer also has access to a database which stores the personal information and search data for each PDD user. In this embodiment, the user can wirelessly download the personal information and search data from the area computer and does not have to store the personal information or search data on the PDD. This embodiment may utilize multiple host computers each storing different personal information and search data for a user. The different personal information and search data files allows the user to have a first set of personal information and search data for a first venue and have a completely different set of personal information and search data for a second venue. If the user's electronic files are not stored on the host computer database, the default personal information and search data stored on the PDD may be used.

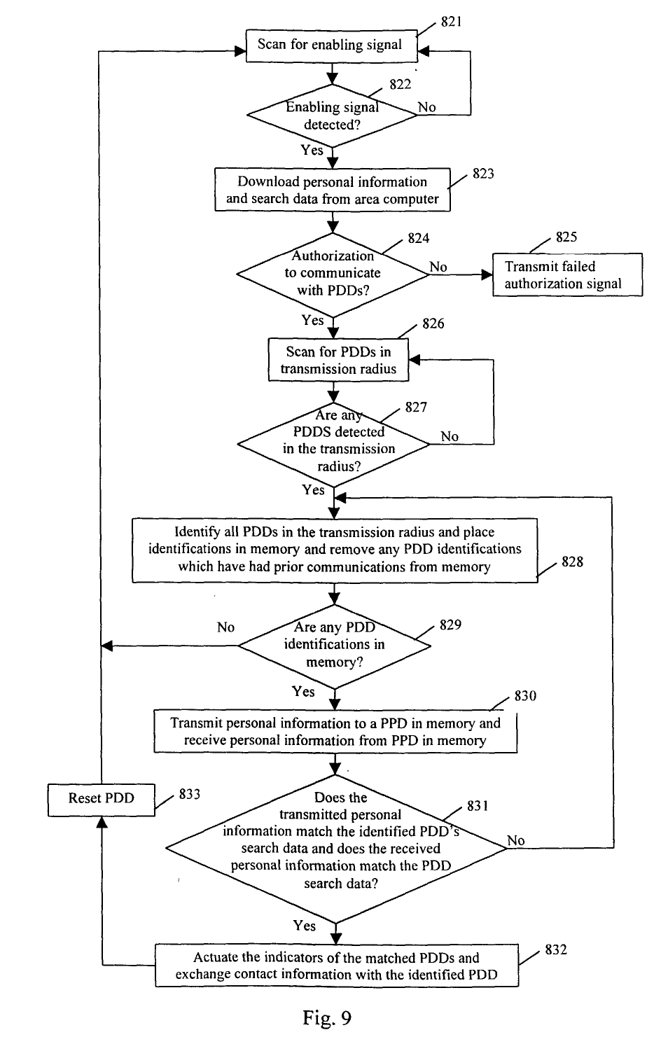

FIG. 9 is a flowchart which describes the operation of the PDD in the area computer embodiment. The PDD first scans for the enabling signal 821 which is transmitted by the area computer. This process may include monitoring the PDD transceiver for the enabling signal 822. If the enabling signal is received the PDD transmits an identification code to the area computer. The area computer responds to the identification code by transmitting the user's personal information and search data to the PDD 823. The area computer then determines if the PDD is authorized to communicate 824. A PDD may fail to be authorized for various reasons including a failure to pay service billings and abuse of the system rules. If the PDD is not authorized, an authorization failure signal is transmitted to the PDD and an indication of authorization failure may be displayed by the PDD 825.

After authorization, the PDD can scan the area for other PDDs as previously described 826. The PDD then determines if there are any PDDs detected in the transmission radius. 827. Once one or more PDDs are detected in the transmission radius (local PDDs), the identification codes of the PDDs are placed in memory 828. Any PDDs which have had prior communications are removed from memory 828. The PDD determines if there are any identification codes in memory 829. If there are no identification codes in memory, the PDD goes back to the enabling signal step 821.

If identification codes are in memory, the PDD transmits the user's personal information to one of the local PDDs in memory and receives the local PDD's personal information 830. A match analysis is performed by both the PDD and the local PDD to determine if the personal information matches the search data 831. If there is a match, the match indicators are actuated on both the PDD and the local PDD and contact information is wirelessly exchanged by the PDD and the local PDD 832. The users of the matched PDDs may be notified of each other's presence and meet in person. After the match indicator is actuated, the PDD must be manually reset to go back to the scan for enabling signal step 833. Alternatively, the match indicator can be deactivated so that the PDD is in a silent mode.

FIGS. 8 and 9 illustrate exemplary methods of operation for the PDD. Various changes can be made to the operating processes without exceeding the scope of the invention. The transmission of information between the PDDs can be performed in several different ways while still achieving the desired analysis. For example, the search data can be exchanged by the PDDs rather than personal information. Alternatively, one PDD can transmit both the personal information and search data to the other PDD which can perform the entire matching analysis alone.

In yet another embodiment, a host computer controls the communications between PDDs and performs all of the match computations for each of the PDDs in the area. The area computer then transmits the identifications codes for matched PDDs to the PDDs. Because PDDs are continuously entering and exiting the venue, the area computer continuously updates the matched PDDs and transmits updated match information to the PDDS. This configuration has the benefit of removing the match analysis processing requirements from the PDDs and allows the area computer to monitor the communications between the PDDs.

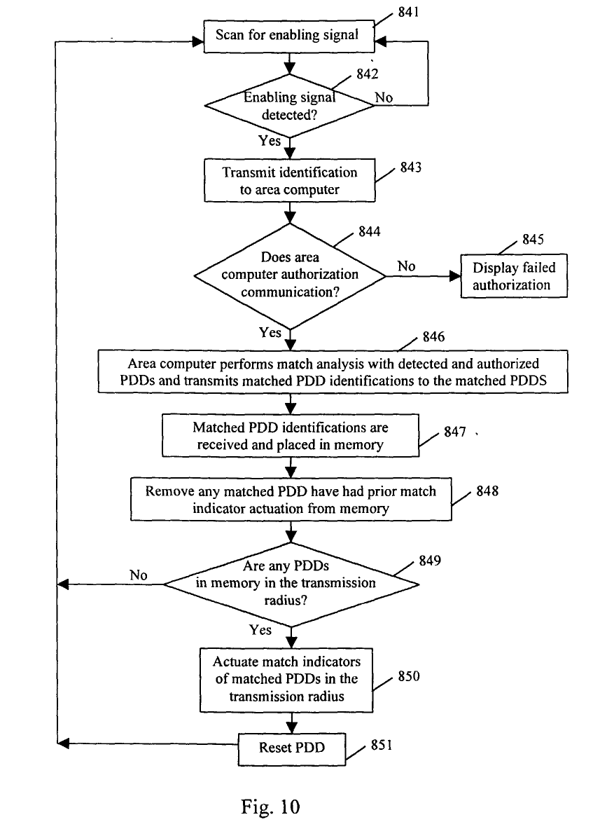

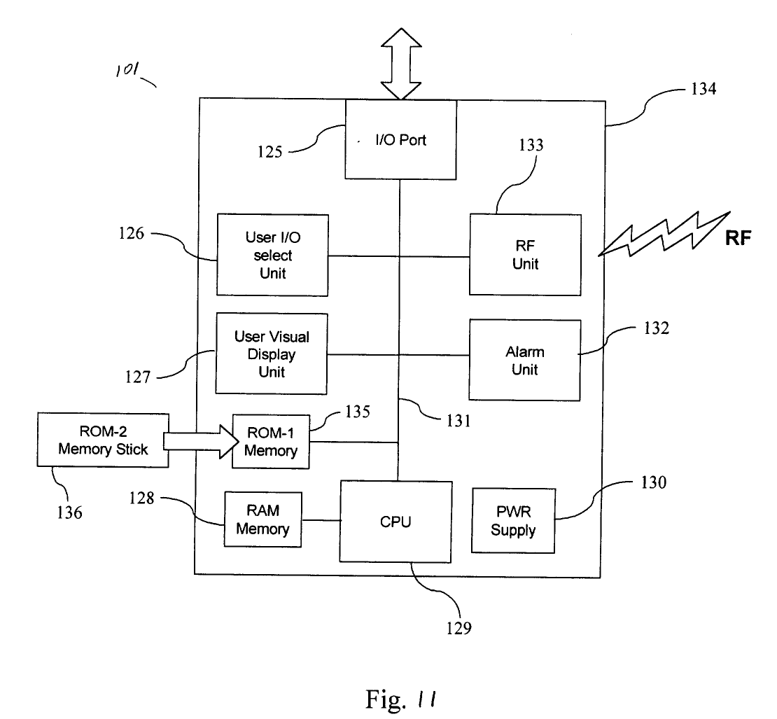

FIG. 10 illustrates a flow chart of the area computer match processing embodiment. The PDD enters an area monitored by the area computer and scans for an enabling signal 841. The PDD then detects the enabling signal 842. If the enabling signal is detected, the identification code for the PDD is transmitted to the host computer 843. The host computer receives the identification code and determines if the PDD is authorized to communicate with other PDDs 844. If the authorization is not granted, a failed authorization signal is transmitted to the PDD 845. Once authorized, the host computer performs a match analysis comparing the personal information to search data between the PDD and all local PDDs detected in the area 846. The host computer continuously performs the analysis and transmits the matched PDDs identification codes to these PDDs.

If a match is detected by the host computer, the PDD receives the identification codes of the matched PDDs and places them in memory 847. The identification codes for PDDs which have previously been communicated with are removed 848. The PDD determines if there are any identification codes in memory and if any of the PDDs associated with the identification code are also within the transmission radius 849. If none of the PDDs associated with the identification codes in memory are within the transmission radius, the PDD goes back to the enabling signal scanning step 841. If there is an identification code in the memory which is within the transmission radius, the match indicators of the matched PDDs are actuated and contact information is exchanged 850. The matched PDD users are informed of each other's presence and can meet face to face. The PDD can be manually reset 851 in order to get back to the scan for enabling signal step 841 after the match indicator is actuated.

For all described modes of operation the PDD requires the same basic components. An exemplary block diagram of the PDD components is illustrated in FIG. 11. The PDD has central processing unit (CPU) 129, ROM memory 135 and RAM memory 128 which store an operating system program, the personal information and search data for the user. The ROM 135 may be connectable to a flash memory socket, which would allow the PDD to store information on and retrieve information from commonly available flash memory devices 136. Commonly available flash memory devices 136 include: memory stick, compact flash, smart media, and secure digital device. The personal information, search data and retrieved contact information can be transferred between the PDD and the personal computer through the removable flash memory 136 alone without the need for the PDD 101 to communicate directly with the personal computer.

The CPU may be connected to an I/O port 125, a user I/O select unit 126, a user visual display unit 127, an RF unit 133 and a match indicator unit 132. The I/O port 125 is used to communicate and exchange information with the computer. Typically, the I/O port 125 utilizes a wired connection which is described in reference to FIG. 6. The I/O select unit 126 allows the user to manually control the operation of the PDD 101. The I/O select unit 126 can include: an on/off button, a reset button for turning off the match indicator and restarting the scan process, or a match indicator mode button.

Alternatively, the I/O port 125 may be part of the docking station embodiment described with reference to number 117 of FIG. 6 and not a component of the PDD 101. In this embodiment, because the I/O port is no longer a component of the PDD 101, draw power is not drawn from the power supply 130. The system bus of the PDD 101 is connected to the docking station I/O port through hot insert buffers which allow the PDD 101 to be connected to the computer while a voltage is applied to the electrical contacts.

The PDD 101 may also include a visual display unit 127 which can be an light emitting diode or a liquid crystal alphanumeric display which can display text information from the PDD, a matched PDD or an area computer. The match indicator unit 132 can include various indicator components including: a vibrator, light, speaker, visual display or any other device which may notify the user of a match. The RF unit 133 is a proximity transceiver which can be used to communicate with: other PDDs in the area, personal computers and host computers having compatible RF transceivers. The components of the PDD 101 receive electrical power from a power supply 130, which is preferably a rechargeable battery.

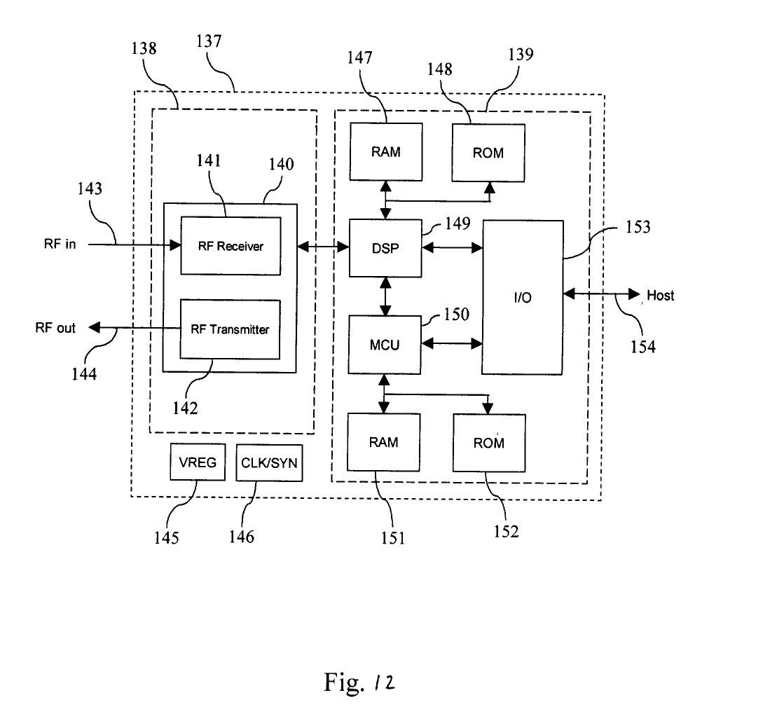

FIG. 12 is a more detailed block diagram of an embodiment of the PDD 101 wherein the RF unit 140, CPU 150, input/output 153 and memory 147, 148, 151, 152 are built into a single mixed analog-digital application specific integrated circuit (ASIC) 137 having an analog section 138 and a digital section 139. Alternatively, the RF unit analog section 138 may be fabricated on one chip and the CPU, RAM, ROM digital section 139 may be on a separate chip.

The analog section 138 has a radio unit 140 having an RF receiver 141 for receiving RF input signals 143 and an RF transmitter 142 for transmitting RF output signals 144. Power to the analog section 138 is controlled by a voltage regulator 145. The analog section 138 may also utilize a clock synthesizer 146 for RF signal processing. In an embodiment, the analog section 138 may communicate with the digital section 139 through a digital signal processor (DSP) 149. The DSP 149 converts the analog signals into digital signals alternatively a analog/digital converter may be used. The DSP 149 has access to RAM 147 and ROM 148. Algorithms may be used to convert the analog signals to digital signals, perform error checking and correction as well as remove noise from the analog signals . The algorithms are stored in the ROM 148 and loaded into RAM 147 when needed by the DSP 149 for analog signal processing. When improvements to the algorithms are made the ROM 148 can be reflashed to load the new algorithms and keep the PDD 101 up to date with the latest software requirements and RF communications protocols.

In an embodiment, the digital signals from the DSP 149 are processed by a microcontroller unit (MCU) 150. As discussed, PDD performs various functions such as scanning for other PDDs/enabling signal, transmitting identification information, receiving personal information, communicating with a host computer, comparing personal information to search data, actuating the match indicator when a match is detected. The MCU 150 performs these tasks using programs stored in the RAM 151. Again, the programs are loaded into the RAM 151 from the ROM 152 and software updates can be loaded into the PDD by reflashing the ROM 152.

The I/O 153 may act as an interface between the DSP 149 and the MCU 150. As discussed, the I/O 153 can receive instructions from the user select unit and display information on the user visual display unit. The I/O 153 can also actuate the match indicator. The integration of the analog and digital sections of the device into one or two ASICs will minimize the size and simplify the construction of the PDD 101.

As discussed, when the personal information of the users matches the search data, the match indicators of the PDDs are actuated. The PDD match indicators can have several modes of operation which may be controlled by the user. These modes of operation may include: ghost, blink, vibrate, random and cloak. Each mode has distinct characteristics which may be selected depending upon how the user would like to use the PDD. When the PDD is matched in ghost mode, the contact information is wirelessly exchanged, but the indicator is not actuated to immediately inform the user of a match.

When the PDD is matched in the blink mode, contact information is wirelessly exchanged, a vibrator may be actuated and a light on the matched PDD is illuminated. The illuminated light can be seen by the user of the PDD as well as the matched PDD user. The lights of the matched PDDs may be coordinated so that they blink at the same frequency or are the same color so that the matched PDDs can more easily locate each other.

When the PDD is matched in vibrate mode, contact information is wirelessly exchanged and a mechanical vibrator in the PDD runs. The vibration notifies the wearer that a match has been detected but people around the user will not know that the user's PDD indicator has been actuated. In an embodiment, the light or vibration indicators are only actuated when they are within a predetermined proximity of the matched PDD and are deactivated when the distance between the matched PDDs exceeds the predetermined distance. If the matched PDD come within the predetermined distance, the match indicators are reactivated. The intermittent actuation of the match indicator is terminated when the PDD is reset or the match indicator is turned off.

When matched in random mode, the seach data is of the PDD is removed and the PDD is matched when any other PDDs in the transmission radius which are also in random mode is detected. The indicators of the random mode PDDs are actuated when a random match is detected. The contact information may or not be exchanged.

When matched in the cloak mode, the user's PDD can detect matched PDDs that are not in cloak mode but the other PDDs cannot detect the user. The user can receive contact information from the matched PDD which is not in cloak mode, but the other PDD does not receive the contact information of the cloaked PDD. Similarly, the indicator on the cloaked user's PDD may actuate to inform the user of a match, but the other matched PDD's indicator is not actuated. Table 2 provides a chart of the possible PDD responses to being matched.

TABLE 2

| | Cloak | Ghost | Vibrate | Blink | Random |
|---|---|---|---|---|---|
| Contact Information | Yes | Yes | Yes | Yes | No |
| Received From | | | | | |
| PDD's Not In Cloak | | | | | |
| Mode | | | | | |
| Contact Information | No | Yes | Yes | Yes | No |
| Transmitted | | | | | |
| Match Indicator | Optional | No | Vibration | Light & | Yes |
| | | | | Vibration | |

Because of the varied responses to a match, some modes of operation are incompatible with other modes. For example, two PDDs in cloaked mode without the light or vibration enabled may be matched but there may be no resulting interaction because contact information is not transmitted and the indicators have been disabled.

In the preferred embodiment, the user can use the contact information to obtain additional information about the matched users through a PDD user database which is accessible through an internet connection. As discussed, the PDD has a limited memory which may be insufficient to store a significant quantity of information. In order to obtain additional information about the matched users, the PDD must be connected to the computer. A program automatically extracts the contact information collected in the PDD's memory. The program accesses the server computer through the internet and obtains access to the matched user's files using the contact information. The user files in the database may include more details about the matched user. This additional information may include: a photograph and a detailed personal description written by the user. Because these characteristics are unique to each user, it may be difficult to compress this information to a size which is easily transmittable or stored on the PDD memory.

Certain personal information may be confidential which is only accessed with the user's express permission. In this embodiment, the confidential personal information is stored in a more secure database. When another user attempts to access the confidential personal information, a message is transmitted to the person associated with the confidential personal information informing the user that access is being requested and identifying the requester. The user can either grant or deny access to the requester. Only if access is granted will only the requestor be permitted to access the confidential personal information. If access is denied, the computer transmits a message to the requestor indicating that access to the confidential personal information has been denied.

Because the computer acts as a conduit for all communications in some embodiments, certain PDD user personal information may be monitored and analyzed by the computer. For example, the computer may be able to monitor specific demographics of the patrons. By compiling the demographic information, customer profiles can be generated for venues including: age range, gender, and interests. The analysis of the information can also be used to determine the effectiveness of the system by determining the total number of users in an area and the number of resulting matches. The computer analysis may be useful as a marketing tool to monitor business clientele and improve the knowledge of the target market. The information can also be made available over the internet allowing internet users access to a detailed description of the club's clientele.

The transmitted identification signal can also used by the computer to determine the presence of a specific individual. In an emergency situation, the computer can indicate whether a specific individual is in the area and transmit a signal to the individual's PDD which notifies the user that he or she is needed.

Various other useful embodiments of the inventive system are available. The PDDs can be used to detect the presence of a specific individual which may be useful when it is necessary to meet a specific person(s) in a crowded space or on a blind date. In this embodiment or mode, the PDDs are loaded with unique personal information and search data which prevents matching with normal PDD users. The match indicators will only be actuated when another PDD with the unique personal information and search data are in the transmission radius.

The inventive system may also be used by visually or hearing impaired individuals to detect other PDD users. For example, a deaf person's PDD may have the match indicator set to vibrate or light and have personal information and search data which includes the deaf characteristic. When another deaf person comes within the transmission radius, the match indicator is actuated informing the user that another deaf person is in the vicinity.

In another embodiment, the inventive system can be used by blind individuals to detect the presence of friends. The PDD can be configured to actuate the match indicator when a friend is detected in the vicinity. The blind individuals and their friends may configure their PDDs in the meeting mode described above. The inventive system allows the physically impaired to discretely detect the presence of friends or others PDD users having a similar impairment.

In the foregoing, a wireless communications system has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A wireless communications system comprising:
a first portable digital device having:
a memory for storing a first user's personal information and search data;
a radio frequency transceiver; and
a match indicator;
a second portable digital device having:
a memory for storing a second user's personal information and search data;
a radio frequency transceiver; and
a match indicator;
wherein the first portable digital device determines that the second portable digital device is a match if the second user's portable digital device is within the transmission radius of the first user's portable digital device, the first user's personal data matches the second user's search data and the second user's personal data matches the first user's search data.

2. The wireless communications system of claim 1 wherein a first user's contact information is stored in the memory of the first portable digital device and if the first portable digital device determines that the second portable digital device is a match, the first user's contact information is transmitted to the second digital device.

3. The wireless communications system of claim 1 wherein the second user's personal information is transmitted to the first portable digital device.

4. The wireless communications system of claim 1 wherein the second user's search data is transmitted to the first portable digital device.

5. The wireless communications system of claim 1 wherein if the first portable digital device determines that the second portable digital device is a match, the match indicator of the first portable digital device is actuated.

6. The wireless communications system of claim 5, wherein the match indicator of the first portable digital device is a visual display which visually indicates that the first portable digital device and the second portable digital device are matched.

7. The wireless communications system of claim 5, wherein the first portable digital device further comprises a switch which allows the match indicator to be reset after being actuated or deactivated.

8. The wireless communications system of claim 5, wherein the first portable digital device further comprises a button which controls the match indicator actuation mode.

9. The wireless communications system of claim 8, wherein the match indicator includes at least one of the following modes of actuation: a visual display, a speaker, or a vibration actuator.

10. The wireless communications system of claim 1 wherein the first portable digital device stores the identification of the second portable digital device in memory to avoid future matching with the second portable digital device.

11. The wireless communications system of claim 1 wherein the first portable digital device can only communicate with the second portable digital device if an enabling signal is received from a host computer.

12. The wireless communications system of claim 1 wherein if the first portable digital device receives a disabling signal from a host computer the first portable digital device cannot communicate with the second portable digital device.

13. The wireless communications system of claim 2 further comprising:
a first user personal computer;
wherein the first user personal information and search data are input into the personal computer and downloaded into the memory of the first portable digital device.

14. The wireless communications system of claim 2 further comprising:
a server computer having a portable digital device user profiles database;
a personal computer; and
a network connected to the personal computer and the server computer;
wherein the first user's contact information is used to access the first user's profile from the person digital device user profiles database

15. A method for matching portable digital devices comprising the steps:
providing a first user's personal information, a first user's search data and a database containing other user's personal information and other user's search data;
searching the database of users with the first user's search data;
finding the personal information of a second user which matches the first user's search data;
comparing a second user's search data to the first user's personal information;
notifying the first user that the second user is a match if the first user's personal information matches second user's search data.

16. The method for matching portable digital devices of claim 15, further comprising the steps of:
detecting the presence of a first user's personal digital device in a defined area; and detecting the presence of a second user's personal digital device in the defined area;
wherein the searching, finding, comparing and notifying steps are performed by a host computer and the notifying step includes actuating a match indicator on the first user's personal digital device.

17. The method for matching portable digital devices of claim 16, further comprising the steps of:
resetting the match indicator of the first portable digital device.

18. A method of matching users comprising the steps:
providing a plurality of portable digital devices each having: a memory for storing an identification code, personal information and search data; a microprocessor for running the operating program; a wireless transceiver; a match indicator; and a battery;
transmitting the identification code for a first portable digital device to a second portable digital device;
determining of the first portable digital device has previously communicated with the second portable digital device;
comparing the second user personal data to the first user search data and the first user personal data to the second user search data if the first portable digital device has not previously communicated with the second portable digital device; and
determining that the first user matches the second user if the second user personal data to the first user search data and the first user personal data to the second user search data if the first portable digital device.

19. The method of matching users of claim 18, further comprising the step:
actuating the match indicator of the first portable digital device if the first user matches the second user.

20. The method of matching users of claim 18, further comprising the step:
transmitting contact information for the first user to the second portable digital device if the first user matches the second user.

21. A portable digital device for wireless communications with other portable digital devices comprising:
a microprocessor;
a microprocessor memory for storing an operating program, a first user's personal information and search data;
a short range RF transceiver for receiving information from a second portable digital device;
a short range RF transceiver memory for storing signal processing algorithms; and
a match indicator;
wherein the operating program compares a second user's personal information to the first search data or compares a second user's search data to the first user's personal information.

22. The portable digital device of claim 21 wherein the microprocessor, microprocessor memory, short range RF transceiver and short range RF transceiver memory are part of a single analog/digital application specific integrated circuit.

23. The portable digital device of claim 21 wherein the microprocessor, the microprocessor memory, the digital signal processor and the short range RF transceiver memory are components of a digital application specific integrated circuit and the short range RF transceiver is a component of an analog application specific integrated circuit.
